(19) United States
(12) Patent Application Publication
(10) Pub. No.: US 2025/0106079 A1
(43) Pub. Date: Mar. 27, 2025

(54) CYCLIC PREFIX ADAPTATION

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US); Yuchul KIM, San Diego, CA (US)

(21) Appl. No.: 18/729,870

(22) PCT Filed: Mar. 29, 2023
(86) PCT No.: PCT/US2023/065088

§ 371 Date: Jul. 17, 2024

(30) Foreign Application Priority Data
Mar. 30, 2022 (GR) 20220100283

(51) Int. Cl. H04L 27/26; H04B 7/06; H04B 17/309

(52) U.S. Cl. CPC H04L 27/2607; H04B 7/0626; H04B 17/346

(57) ABSTRACT

Certain aspects of the present disclosure provide techniques for cyclic prefix (CP) optimization and adaptation. Certain aspects provide a method for wireless communication by a first communications device. The method generally includes determining a first CP length for communicating with a second communications device based on at least one of: an energy charging requirement of the first communications device or the second communications device or a security requirement for communications between the first communications device and the second communications device, and communicating, with the second communications device, a first signal over a first symbol, wherein the first signal comprises a first CP having the first CP length.

### CROSS-REFERENCE TO RELATED APPLICATION(S)

This application claims benefit of and priority to Greece Patent Application Serial No. 20220100283, filed Mar. 30, 2022, which is herein incorporated by reference in its entirety.

### BACKGROUND

### Field of the Disclosure

Aspects of the present disclosure relate to wireless communications, and more particularly, to techniques for cyclic prefix (CP) adaptation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a first communications device. The method includes determining a first cyclic prefix (CP) length for communicating with a second communications device based on at least one of: an energy charging requirement of the first communications device or the second communications device; or a security requirement for communications between the first communications device and the second communications device; and communicating, with the second communications device, a first signal over a first symbol, wherein the first signal comprises a first CP having the first CP length.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example slot having cyclic prefixes (CPs) between symbols.

FIG. 6 is a graph depicting example throughput for different CP lengths in a delay spread channel.

FIG. 7 depicts a process flow for communications in a network between communications devices for CP adaptation.

FIG. 8 depicts a process flow for communications in a network between communications devices for CP adaptation based on, at least, a measured delay spread.

FIG. 9 depicts a process flow for communications in a network between communications devices for CP adaptation based on, at least, a CP length configuration.

FIG. 10 depicts a process flow for communications in a network between communications devices for CP adaptation based on, at least, a change in a transmit precoder and/or transmitting parameters.

FIG. 11 depicts a process flow for communications in a network between communications devices for CP adaptation based on, at least, one or more periodic cycles configured for at least one of the communications devices.

FIG. 12 depicts a process flow for communications in a network between communications devices for CP adaptation based on, at least, a plurality of delay spread measurements.

FIG. 13 depicts a process flow for communications in a network between communications devices for CP adaptation based on, at least, a recommended CP.

FIG. 14 depicts a method for wireless communications.

FIG. 15 depicts aspects of an example communications device.

### DETAILED DESCRIPTION

Aspects of the present disclosure provide apparatuses, methods, processing systems, and computer-readable mediums for cyclic prefix (CP) adaptation. For example, in certain aspects, adaptation may refer to adjusting a length of a CP used for communications, such as based on one or more factors, such as energy charging requirements or security requirements.

In particular, certain aspects of the present disclosure provide techniques for utilizing a CP of a transmitted signal for various purposes, such as not only, in certain aspects, to mitigate the effects of multipath propagation (e.g., where delay spread is concerned), but also, or alternatively, for purposes of (1) increasing security and/or (2) for energy charging. For example, in certain wireless communications systems (e.g., orthogonal frequency division multiplexing (OFDM) systems), a CP may be inserted at the beginning of a symbol to mitigate multipath channel delay spreading, as well as consequent inter-symbol interference (ISI) and inter-carrier interference (ICI). In certain aspects, CP insertion reduces information throughput, affecting spectral and power efficiency. In particular, a CP may not carry useful data thereby not utilizing certain resources for data communication. Accordingly, aspects of the present disclosure suggest further adapting the use of a CP based on security and/or energy charging needs, thereby adding additional benefits to the use of a CP, such that on balance, the affected spectral and power efficiency loss is outweighed by the benefit of the use of the CP for a given situation.

In certain aspects, a length of the CP is adapted based on one or more factors. For example, a shorter CP may provide better spectral efficiency in a wireless communications system and power efficiency at a transmitting device of the CP, while a longer CP may provide better energy charging at a receiving device of the CP and/or security of communications in the wireless communications systems. Therefore, certain aspects herein relate to adapting a length of a CP based on the balance between spectral and power efficiency and security and/or energy charging needs. In particular, in certain aspects, the techniques herein may provide specific scenarios and/or factors to use to better adapt CP length to provide a better balance between spectral and power efficiency and security and/or energy charging needs.

In certain aspects, “artificial noise” may be added or inserted into a CP of a transmitted signal. That is, a transmitter communications device may deliberately add an additional noise signal to transmit as a CP of a transmission, wherein that noise signal in the CP is meant to obscure legitimate aspects (e.g., reference signal (RS), payload, etc.) of the overall transmission. As such, the added noise signal may reduce signal to interference and noise ratio (SINR) at other communications devices and prevent the other communications devices from correctly decoding the legitimate transmission, thereby increasing security of such communications. In certain aspects, the longer the CP length, the larger the amount of additional noise added to the transmission, thereby increasing security, but potentially decreasing power and/or spectral efficiency, as less of the transmission length may be usable for data.

In certain aspects, as a CP of a transmission does not include data, a receiver communications device of a transmission may leverage the radio frequency (RF) signal of the CP of the transmission to harvest energy at the receiver communications device, by converting the RF signal of the CP into energy using known techniques. In certain aspects, such harvested energy may be used to power the receiver communications device, such as to perform at least one of decoding or transmission. The remainder of the transmission may be received and decoded, as it may contain data, and therefore may not be used for energy harvesting. In certain aspects, the longer the CP length, the larger the amount of RF signal for energy harvesting, but potentially decreasing power and/or spectral efficiency, as less of the transmission length may be usable for data.

Accordingly, certain aspects provide techniques for CP adaptation as a function of one or more factors, including at least one of an energy charging requirement and/or a security requirement. In certain aspects, the one or more factors may further include delay spread, a transmitter precoder model, transmitting parameters, subcarrier spacing (SCS), and/or current bandwidth. In certain aspects, however, one factor may suggest a CP length at the cost of another factor.

In certain aspects, a CP length determined for communicating between two communications devices may adapt based on different factors considered at different times, adapt based on a different number of factors considered at different times, or a combination of both. In certain aspects, a CP length used for transmission may be a CP length recommended by a receiver communications device.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

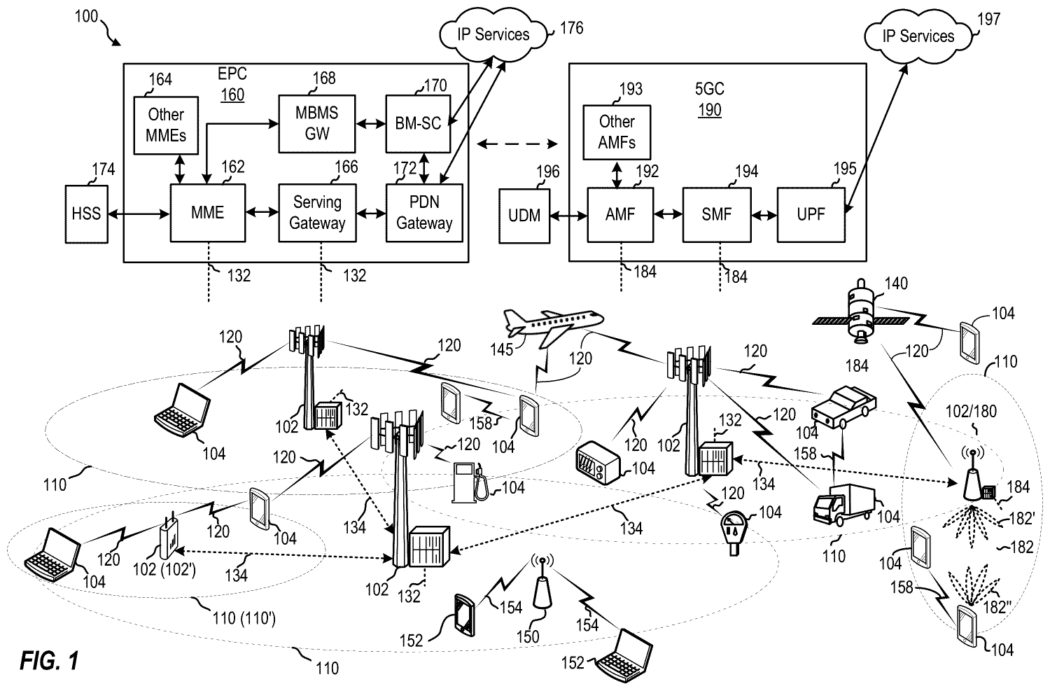

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

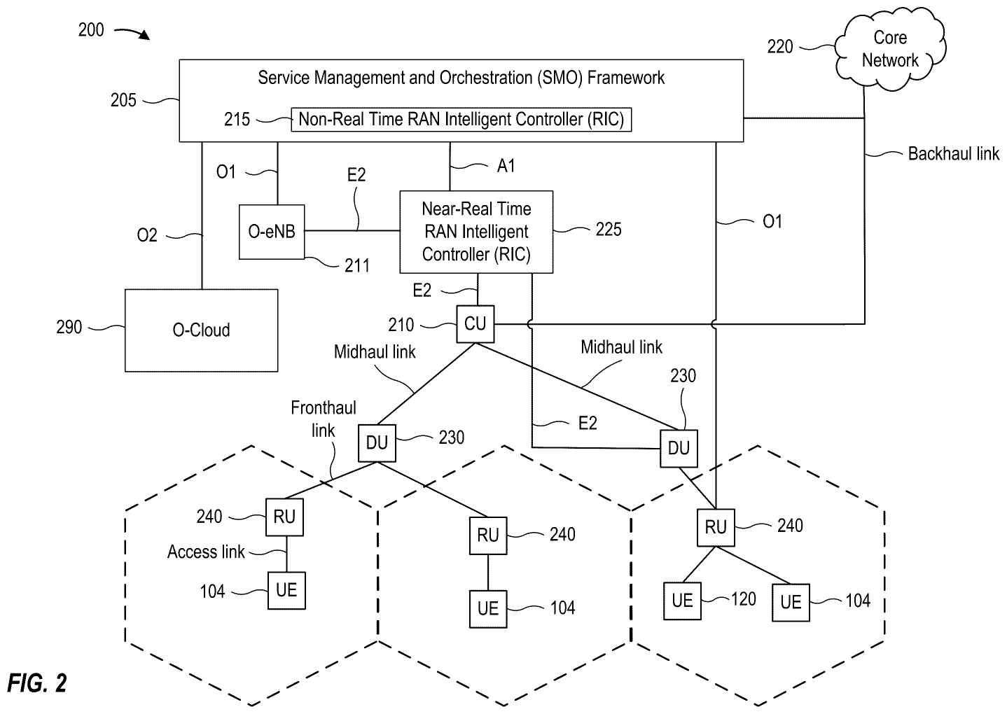

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated BS 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

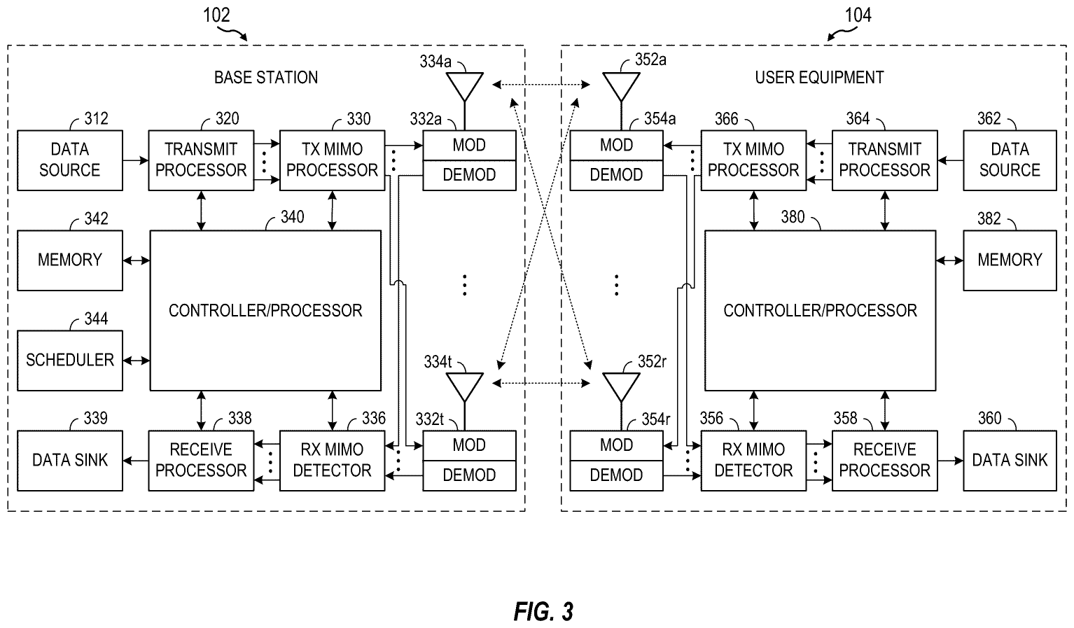

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

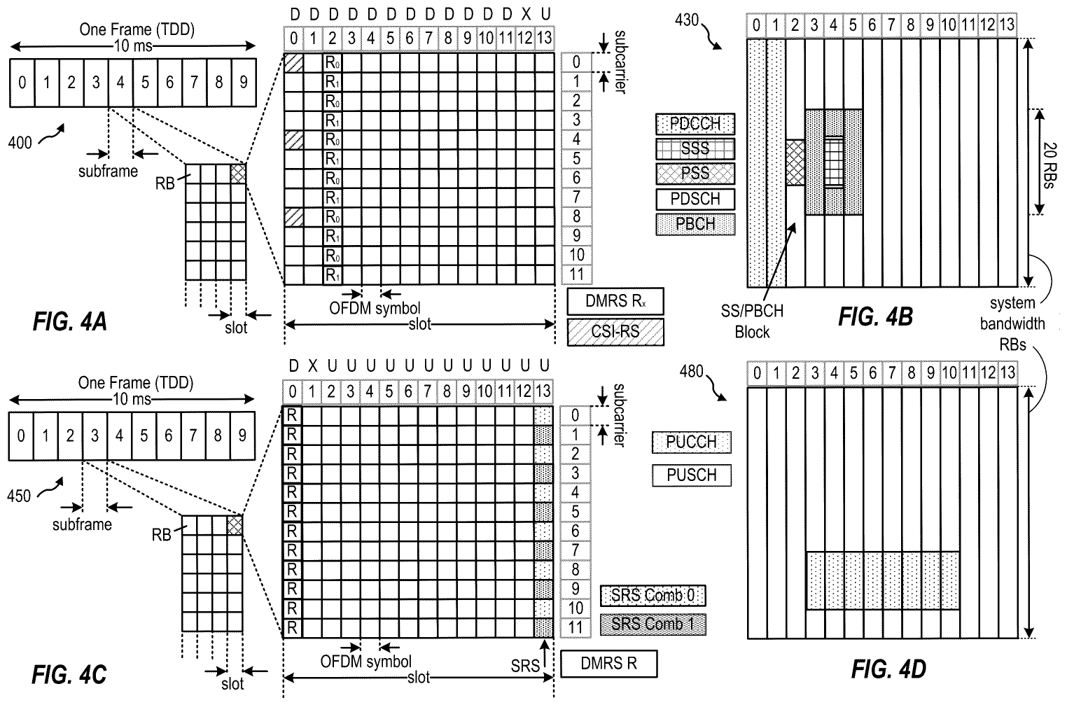

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Cyclic Prefixes (CPs)

In wireless telecommunications, multipath propagation is the phenomenon that results in radio signals reaching a receiving antenna by two or more paths. In other words, a received signal may be dispersed in time. Each path has its own delay thereby causing multiple instances of the same signal to arrive at a receiver at different times. The non-simultaneous arrivals of different instances of the signal at the receiver causes a spread of the original signal in the time domain, which is referred to as the delay spread. Delay spread is a measure of the multipath profile of a mobile communications channel and is generally defined as the difference between the time of arrival of an earliest multipath component (e.g., the line-of-sight wave if there exists) and the time of arrival of a latest multipath component.

Such delay spread can be detrimental to communication systems. For example, in some cases, multipath delay spread can cause inter-symbol interference (ISI), which is a form of distortion of a signal in which one symbol interferes with subsequent symbols. ISI may severely affect the transmission quality of digital signals. Further, in some cases, multipath delay spread may cause inter-channel interference (ICI). ICI can cause the orthogonality of subcarriers in an orthogonal frequency division multiplexing (OFDM) to become damaged thereby affecting the demodulation at a receiver.

A cyclic prefix (CP) may be used to counter such effects of multipath propagation. In particular, a CP is a guard period made up of a replica of a time-domain OFDM waveform. The CP is a replicated part of the back of an OFDM signal that is used at the start of an OFDM symbol to create the guard period.

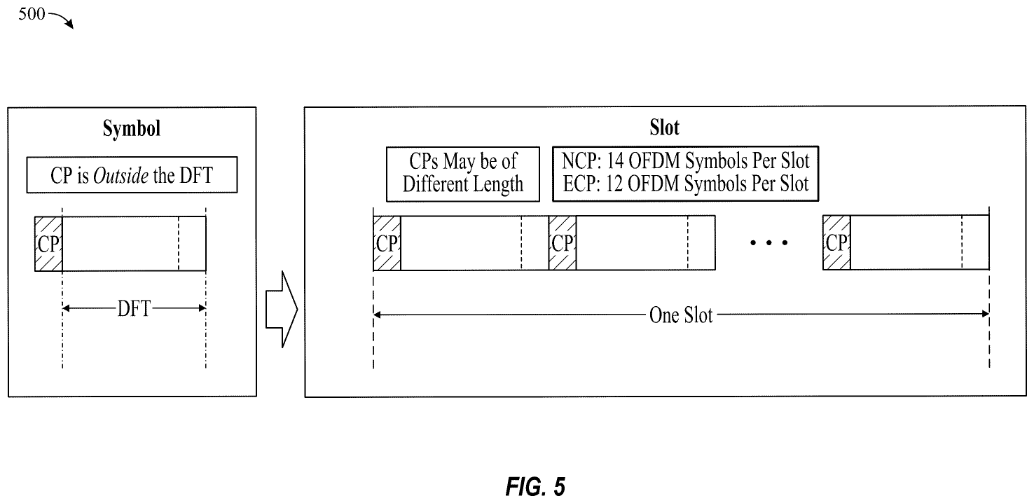

FIG. 5 depicts an example slot 500 having CPs between symbols. As illustrated in FIG. 5, a CP may be slot-contained. CPs may have different durations (interchangeably referred to herein as “lengths”). For example, a “normal” CP (NCP) length may be used for slots that have 14 OFDM symbols, while an extended CP (ECP) length may be used for slots that have 12 OFDM symbols.

Further, as illustrated in FIG. 5, a CP typically falls outside of a Discrete Fourier Transform (DFT). In particular, a CP may be implemented after inverse DFT (IDFT). Only data may undergo a DFT and subsequent IDFT. Accordingly, the CP may be added after the IDFT, and the combination of data and CP may be transmitted.

CP usage may preserve the orthogonality of subcarriers and prevent inter-symbol interference (ISI) between successive symbols, as well as ICI. The CP may also help to enable linear to circular convolution conversion. However, a CP may not carry any useful data, as such, a receiver may be configured to discard the CP. For example, the CP may include random data, the random data itself having minimal function. Thus, overhead may be present with CP usage in OFDM systems.

### Aspects Related to Cyclic Prefix (CP) Adaptation

Aspects of the present disclosure introduce techniques for cyclic prefix (CP) adaptation, as discussed. For example, aspects of the present disclosure adapt the use of a CP for security and/or energy charging purposes.

For example, providing secure wireless communications (e.g., downlink (DL), uplink (UL), and/or sidelink communications) between a first communications device (e.g., a base station (BS), a user equipment (UE), and/or the like) and a second communications device (e.g., a BS, a UE, and/or the like) is important in wireless communications systems. However, ensuring such security may be a challenging problem due to the shared nature of the wireless medium and/or the lack of security for particular channels and/or protocol stack layers for particular communications devices in the wireless communications system.

For example, a physical downlink control channel (PDCCH), a physical sidelink control channel (PSCCH), and/or a physical uplink control channel (PUCCH) may not be secure. Thus, downlink control information (DCI) transmitted on a PDCCH, sidelink control information (SCI) transmitted on a PSSCH, and/or uplink control information (UCI) transmitted on a PUCCH may be susceptible to eavesdropping by a receiver communications device not intended for such communication.

For example, Table 1, provided below, depicts example signaling security at different layers of a receiver communications device. In particular, different layers (e.g., Layer 1 (L1), Layer 2 (L2), and Layer 3 (L3), or a physical (PHY) layer up to a radio resource control (RRC) layer) of a protocol stack may be implemented by a communications device operating in the wireless communications system. In various examples, the layers of the protocol stack may be implemented as separate modules of software, portions of a processor or ASIC, portions of non-collocated devices connected by a communications link, or various combinations thereof. Further, “IDLE/INACTIVE”, “TRANSITION”, and “CONNECTED” labels in Table 1 below may represent three RRC states of the receiver communications device, for example, defined by 3GPP standards.

TABLE 1

| | IDLE/INACTIVE | TRANSITION | CONNECTED |
|---|---|---|---|
| L3 RRC | System | CCCH | DCCH |
| | information, | | |
| | Paging | | |
| L2 UP data | N/A | N/A | DTCH |
| L2 control | N/A | MAC-CE | MAC-CEs, Control |
| | | | PDU |
| L2 header | N/A | MAC | PDCP/RLC/MAC |
| L1 PHY | DCI for SI, | DCI for the | DCI/PUCCH |
| | Paging | initial access | |

As illustrated in Table 1, for a receiver communications device, only a dedicated traffic channel (DTCH) (e.g., at L2 while in the “CONNECTED” state) and a dedicated control channel (DCCH) (e.g., at L3 while in the “CONNECTED” state) between a transmitter communications device and the receiver communications device may be protected (e.g., shown in the table as bold and underlined). Accordingly, while in the “CONNECTED” state, medium access control (MAC)-control element (CE) signaling, control protocol data unit (PDU) signaling, signaling at the packet data convergence protocol (PDCP) layer, signaling at the radio link control (RLC) layer, and control channel signaling (e.g., DCI on PDCCH and UCI on PUCCH) may be considered to be unprotected signaling. Further, while in the “TRANSITION” state, signaling at the common control channel (CCCH), MAC-CE signaling, and control channel signaling (e.g., DCI on PDCCH) may be considered to be unprotected signaling. Additionally, while in the “IDLE/INACTIVE” state, system information (SI) signaling, paging, and control channel signaling (e.g., DCI on PDCCH) may be considered to be unprotected signaling.

As another example, certain devices in the wireless communications system may not have upper layer security. For example, an intelligent reflecting surface (IRS) (also referred to as a “reconfigurable intelligent surface”, a “reflecting intelligent surface”, a “reconfigurable impedance surface”, an “intelligent reflection surface”, or an “intelligent reconfigurable surface”) and/or other passive internet of things (IoT) controllers may not have upper layer security. As is known in the art, an IRS is a device configured with a codebook for precoding one or more elements thereon (referred to as IRS elements) to allow a beam from one communications device to be re-radiated off the IRS to reach another communications device.

For the reasons described above, transmitters may need to implement additional security measures (e.g., specifically at lower layers, per Table 1 provided above) to prevent other communications devices from decoding data that is not intended for them. Accordingly, aspects of the present disclosure suggest utilizing CPs to increase the security of communications between two or more communications devices. For example, in certain aspects, “artificial noise” may be added or inserted into a CP of a transmitted signal. That is, a transmitter communications device (e.g., a UE and/or a BS) may deliberately add an additional noise signal to transmit as a CP of a transmission, wherein that noise signal in the CP is meant to obscure legitimate aspects (e.g., reference signal (RS), payload, etc.) of the overall transmission. As such, the added noise signal may reduce signal to interference and noise ratio (SINR) at other communications devices and prevent the other communications devices from correctly decoding the legitimate transmission.

The transmitter communications device may generate the noise signal using any suitable algorithm or technique. The noise signal may include a randomized signal, an additive white Gaussian noise (AWGN) signal, or any other suitable noise signal that may be filtered/canceled from a transmission by the receiver communications device.

The addition of a CP into a transmitted signal causes an equivalent channel matrix at a receiver communications device side to be wide. For example, the equivalent channel matrix may include a null space (e.g., N_{cp}) at the receiver communications device. In particular, the equivalent channel matrix may be represented by R^{cp} H T^{cp}∈C^{N×N+N}^{_{cp}} where R^{cp} represents the received signal at the intended receiver communications device, H represents a channel between the transmitter communications device and the intended receiver communications device, TOP represents the transmitted signal at the transmitter communications device, N×N represents the size of the channel, and N_{cp} represents the null space.

Accordingly, time-domain “artificial noise” may be added or inserted into the transmitted signal due to the presence of the CP creating a null space. Further, increasing a CP length added to a transmitted signal may allow for more “artificial noise” to be added or inserted into the transmitted signal, thereby increasing security of communications between a transmitter communications device and a receiver communications device.

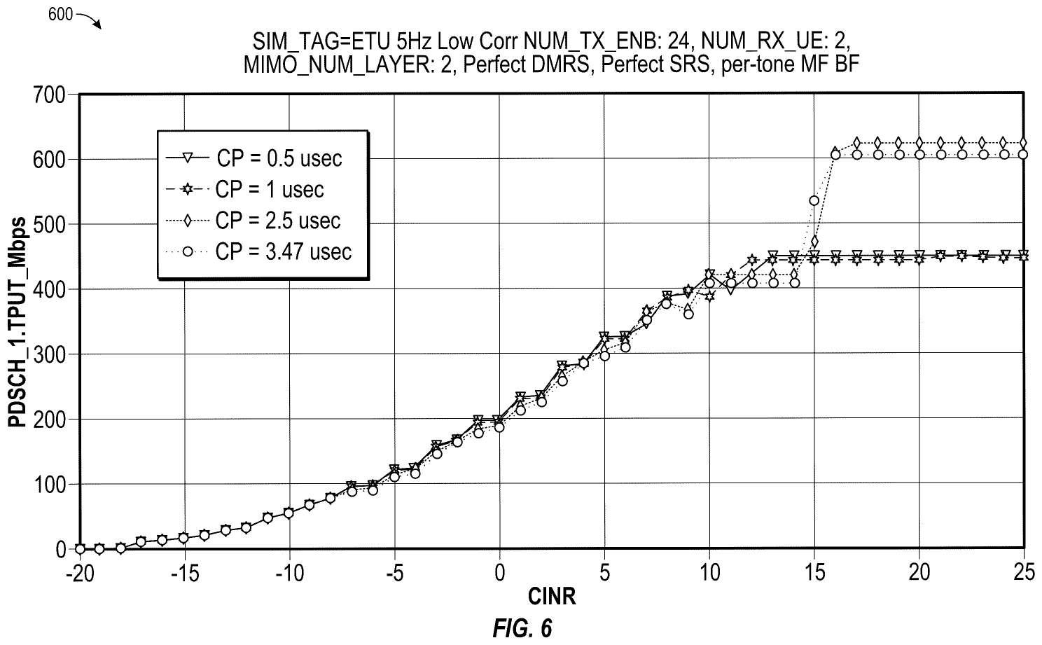

In certain aspects, random CP length selection may also be considered to increase the security of wireless communications. For example, a plurality of CP lengths which are feasible given the expected channel delay spread (e.g., may be less than the channel delay spread as illustrated in FIG. 6 below), for purposes of preventing ISI and/or ICI, may be determined. Among this plurality, a CP length may be chosen at random for use in a transmitting signal. The randomization of selection of the CP length may help to confuse eavesdroppers of the communication, as well as active attackers.

In addition to optimizing the use of a CP for security (e.g., as described above), certain aspects of the present disclosure also suggest to further optimize the use of a CP for energy charging purposes. For example, in certain aspects, a higher power radio frequency (RF) signal may be added or inserted into a CP of a transmitted signal. That is, a transmitter communications device (e.g., a UE and/or a BS) may deliberately add a higher power RF signal to a transmission, and a receiver communications device may be configured to leverage the RF signal for energy harvesting.

In particular, energy harvesting is the conversion of one form of energy into electrical energy for use in powering electronic devices. As such, a receiver communications device may leverage the RF signal in the CP of the transmitted signal to harvest energy at the receiver communications device. In certain aspects, such harvested energy may be used to power the receiver communications device. Accordingly, increasing a CP length added to a transmitted signal may allow for additional energy to be harvested for powering a receiver communications device.

In certain aspects, the energy charging requirement may be measured based on an amount of energy to be transferred, and/or an amount of energy storage (e.g., capacity) the receiver communications device (e.g., the energy harvesting device) has. In certain aspects, the receiver communications device may indicate its amount of energy to be transferred and/or energy storage capacity to the transmitter communications device, such as part of a capability of the receiver communications device (e.g., using RRC signaling or other suitable signaling). In certain aspects, energy storage capacity of the receiver communications device may be defined based on a class and/or type of the receiver communications device. Accordingly, the class and/or type of the receiver communications device may be communicated to the transmitter communications device as part of capability signaling for the receiver communications device, the class and/or type implicitly indicating the energy storage capacity.

Certain aspects provide techniques for CP adaptation as a function of an energy charging requirement and/or a security requirement, in addition or alternative to delay spread requirements.

For example, as described in detail above, aspects of the present disclosure suggest utilizing a CP of a transmitted signal not only to mitigate the effects of multipath propagation (e.g., where delay spread is concerned), but also (or alternatively) for purposes of (1) increasing security via the insertion of “artificial noise” and/or (2) energy harvesting. Thus, one or more factors, such as delay spread, energy charging requirements, and/or security requirements, may be considered when determining a CP length to use for a transmitted signal. Other factors to consider when determining CP length may include subcarrier spacing (SCS) and/or current bandwidth. In certain aspects, however, one factor may suggest a CP length at the cost of another factor.

For example, to increase an amount of energy which may be harvested by a receiver communications device and/or to improve security by the insertion of “artificial noise”, a larger CP length may be desired for the transmitted signal. However, a larger CP length may result in reduced information throughput of the transmitted signal. On the other hand, to reduce CP overhead and increase through output, as well as spectral and power efficiency of a transmitted signal, a smaller CP length may be selected for the signal. However, the smaller CP length may not allow for the addition of as much “artificial noise” to reduce the SINR of the signal to a potential eavesdropper, may not allow for sufficient energy harvesting to occur to power the receiver communications device, and/or may not be large enough to mitigate ISI and ICI caused by multipath propagation.

Accordingly, aspects of the present disclosure may consider multiple factors prior to determining a CP length for transmission. For example, as shown in FIG. 6, instead of using a fixed CP length defined in 3GPP specifications, the CP length may be adapted, not only with respect to ISI and/or ICI mitigation, but also for security purposes or energy charging purposes.

FIG. 6 is a graph 600 depicting example throughput for different CP lengths in a delay spread channel. As shown in FIG. 6, the delay spread channel may be the extended typical urban (ETU) channel which has a 5 usec maximum delay spread. Thus, in some cases, a CP length selected to mitigate such delay spread in the channel may be selected to be 5 usec. However, in some other cases, a CP length less than 5 usec may be feasible while still achieving peak throughput performance gains. For example, as shown in FIG. 6, a CP length may be reduced down to 2.5 usec and still achieve peak throughput for the channel. Thus, a CP length to account for the delay spread of the channel may range between 2.5 usec and 5 usec.

In certain aspects of the present disclosure, rather than using the defined 5 usec CP length for transmission, a CP length between 2.5 usec and 5 usec may be chosen at random. Using a random value between 2.5 usec and 5 usec may help to secure communication between two communications devices. For example, an eavesdropper listening to the communication may not know the CP length used in the transmission, and incorrectly cut the signal (e.g., may use a CP length different than a CP length used in the transmission) resulting in degradation of the signal at the eavesdropper. Further, the selected CP length may change over time, in some cases due to delay spread and/or security requirements also changing.

In certain aspects, a CP length determined for communicating between two communications devices may adapt based on different factors considered at different times. For example, at a first time, t1, a CP length determined for communication may be based on an energy charging requirement of the receiver communications device. Whereas, at a second time, t2, a CP length determined for communication may be based on a security requirement for such communication. Accordingly, at each time, a single factor may be considered for determining the CP length; however, the factor considered at t1 may be different than the factor considered at t2.

In certain aspects, a CP length determined for communicating between two communications devices may adapt based on a change in a number of factors considered at different times. For example, at a first time, t1, a CP length determined for communication may be based on an energy charging requirement of the receiver communications device. Whereas, at a second time, t2, a CP length determined for communication may be based on an energy charging requirement of the receiver communications device and a security requirement for such communication. Accordingly, a number of factors considered at t1 (e.g., one factor) may be different than a number of factors considered at t2 (e.g., two factors) for determining a CP length at different times.

In certain aspects, a CP length determined for communicating between two communications devices may adapt based on different factors considered at different times, as well as a change in a number of factors considered at different times.

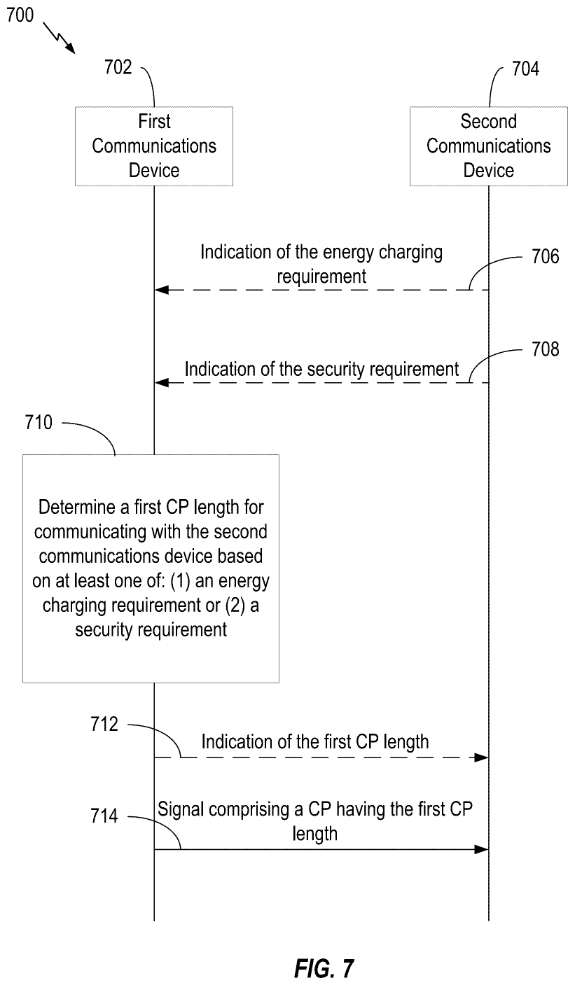

FIGS. 7-13 depict process flows 700-1300, respectively for communications in a network between communications devices for CP adaptation. As shown in process flow 700-1300, a first communications device (e.g., a base station (BS) 102 illustrated in FIGS. 1 and 3, a user equipment (UE) 104 illustrated in FIGS. 1 and 3, and/or the like) may be engaging in wireless communication (e.g., downlink (DL), uplink (UL), and/or sidelink communications) with a second wireless communications device (e.g., a BS 102 illustrated in FIGS. 1 and 3, a UE 104 illustrated in FIGS. 1 and 3, and/or the like).

According to aspects described herein, the first communications device 702 (referred to herein as “device 702” or the transmitter communications device) may transmit a signal to the second communications device (referred to herein as “device 704” or the receiver communications device) over a symbol, wherein the signal includes a CP having a particular CP length. Different options for determining the CP length and/or changing the CP length for different signal transmissions may be described in detail with respect to process flow 700-1300 of FIGS. 7-13, respectively.

FIG. 7 depicts a process flow 700 for communications in a network between communications devices for CP adaptation. As shown, process flow 700 begins, at 710, by device 702 determining a first CP length for communicating with device 704. Device 702 may determine the first CP length based on at least one of: (1) an energy charging requirement or (2) a security requirement for communications between device 702 and device 704.

The energy charging requirement may be a required amount of energy needed to decode a signal transmitted by device 702 with the determined CP length and/or transmit a second signal. In certain aspects, the energy charging requirement may be an energy charging requirement of device 702. In certain other aspects, the energy charging requirement may be an energy charging requirement of device 704. Accordingly, in certain aspects, at 706, device 704 may transmit an indication of the energy charging requirement to device 702.

For example, device 704 may require X amount of energy to decode a signal transmitted by device 702 with the determined CP length (e.g., where X is a value greater than zero). Accordingly, at 706 (e.g., prior to device 702 determining the first CP length), device 704 transmits to device 702 an indication that device 704 requires X amount of energy to decode a signal transmitted by device 702. In certain aspects, device 704 further indicates an efficiency in its energy conversion process. In certain aspects, device 704 determines the first CP length based on this indicated energy charging requirement.

The security requirement may be an SINR degradation requirement. In certain aspects, at 708, device 704 transmits an indication of the security requirement to device 702.

For example, device 704 may determine a channel between device 702 and device 704 is not secure (e.g., as described in detail above with respect to Table 1). Accordingly, device 704 may determine SINR needs to be degraded by X %. In certain aspects, the SINR of communications between device 702 and device 704 may be degraded by adding or inserting “artificial noise” into a CP of a transmitted signal. Accordingly, at 708 (e.g., prior to device 702 determining the first CP length), device 704 transmits to device 702 an indication that SINR needs to be degraded by X %. In certain aspects, device 704 determines the first CP length based on this indicated security requirement.

Optionally, at 712, device 702 transmits, to device 704, an indication of the first CP length determined at 710. In certain aspects, the indication of the first CP length is transmitted via at least one of downlink control information (DCI), a medium access control (MAC) control element (CE), a physical downlink control channel (PDCCH), a physical downlink shared channel (PDSCH), or radio resource control (RRC) signaling.

At 714, device 702 transmits a signal over a first symbol, wherein the signal comprises a CP having the first CP length determined at 710. Where a signal previously transmitted to device 702 included a different CP length, the signal transmitted at 710 having the first CP length may have (1) increased/decreased energy transfer, (2) increased/decreased security, and/or (3) increased/decreased throughput in comparison to the previously transmitted signal. In certain aspects, the increase/decrease in energy transfer, security, and/or throughput may have a direct correlation to which factor(s) (e.g., an energy charging requirement, a security requirement, and/or other requirements) device 702 used in determining the first CP length.

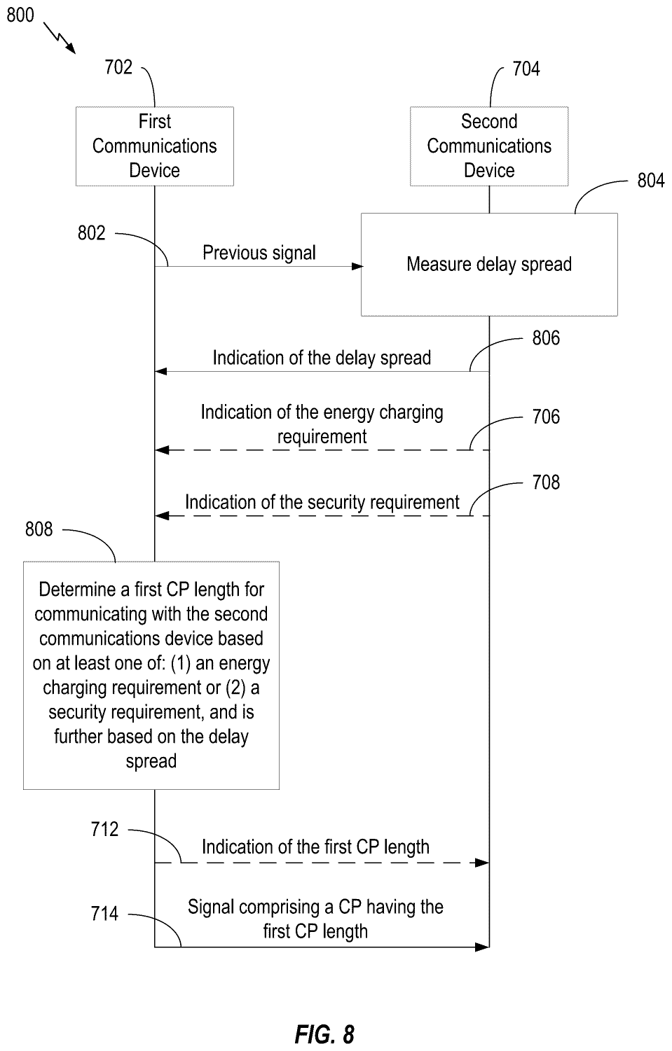

FIG. 8 depicts a process flow 800 for communications in a network between communications devices for CP adaptation based on, at least, a measured delay spread. In addition to determining a first CP length based on at least one of (1) an energy charging requirement or (2) a security requirement for communications between device 702 and device 704 (e.g., as illustrated in FIG. 7), in FIG. 8, the first CP length may be further based on a delay spread between device 702 and device 704.

As shown, process flow 800 begins, at 802, by device 702 transmitting a signal (e.g., a previous signal) to device 704, and device 704, at 804, measuring an effective delay spread of the transmitted signal. At 806, device 704 transmits an indication of the measured delay spread to device 702.

At 808, device 702 determines a first CP length for communicating with device 704. Device 702 may determine the first CP length based on at least one of: (1) an energy charging requirement or (2) a security requirement for communications between device 702 and device 704, and further based on the indicated delay spread.

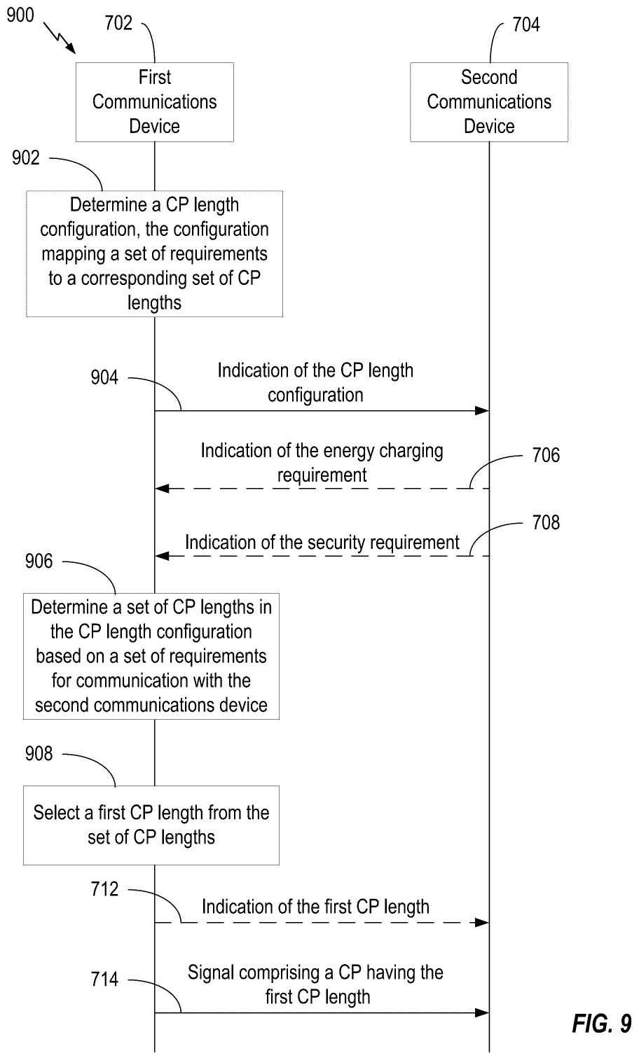

FIG. 9 depicts a process flow 900 for communications in a network between communications devices for CP adaptation based on, at least, a CP length configuration. In certain aspects, device 702 may configure and allow for certain CP lengths for different sets of requirements. In particular, as shown in FIG. 9 at 902, device 702 determines a CP length configuration, wherein the CP length configuration associates each set of requirements of a plurality of sets of requirements with a corresponding set of CP lengths. Each of the plurality of sets of requirements includes one or more of a corresponding energy charging requirement, a corresponding security requirement, or a corresponding transmission parameter.

As an illustrative example, a CP length configuration determined by device 702, at 902, may include three mappings. A first mapping may map a first set of requirements to a first set of five CP lengths. The first set of requirements may include a first energy charging requirement range (e.g., a first energy range needed for decoding a signal) and a first security requirement range (e.g., a first SINR degradation range). A second mapping may map a second set of requirements to a second set of five CP lengths. The second set of requirements may include a second energy charging requirement range (e.g., a second energy range needed for decoding a signal) and a second security requirement range (e.g., a second SINR degradation range). A third mapping may map a third set of requirements to a third set of five CP lengths. The third set of requirements may include a third energy charging requirement range (e.g., a third energy range needed for decoding a signal) and a third security requirement range (e.g., a third SINR degradation range). In this example, the first set of five CP lengths may include CP lengths that are less than the second set of five CP lengths and the third set of CP lengths. Further, the second set of five CP lengths may include CP lengths that are less than the third set of five CP lengths (e.g., (first set of CP lengths)< (second set of CP lengths)< (third set of CP lengths). In certain aspects, sets having smaller CP lengths may be mapped to sets of requirements containing lower modulation and coding schemes (MCSs) and/or higher block error rates (BLERs).

At 904, device 702 transmits an indication of the CP length configuration to device 704. At 906, device 702 determines a set of CP in the CP length configuration based on a set of requirements for communication with device 704. At 908, device 702 selects a first CP length from the set of CP lengths determined at 906.

For example, using the example configure described, at 906, device 702 may determine a set of requirements for communication with device 704 matches (e.g., falls within ranges for) the first set of requirements in the first mapping. Accordingly, device 702 may use the mapping for the first mapping to determine the first set of five CP lengths. At 908, device 702 may select a CP length among the five CP lengths in the set as the first CP length, e.g., at random.

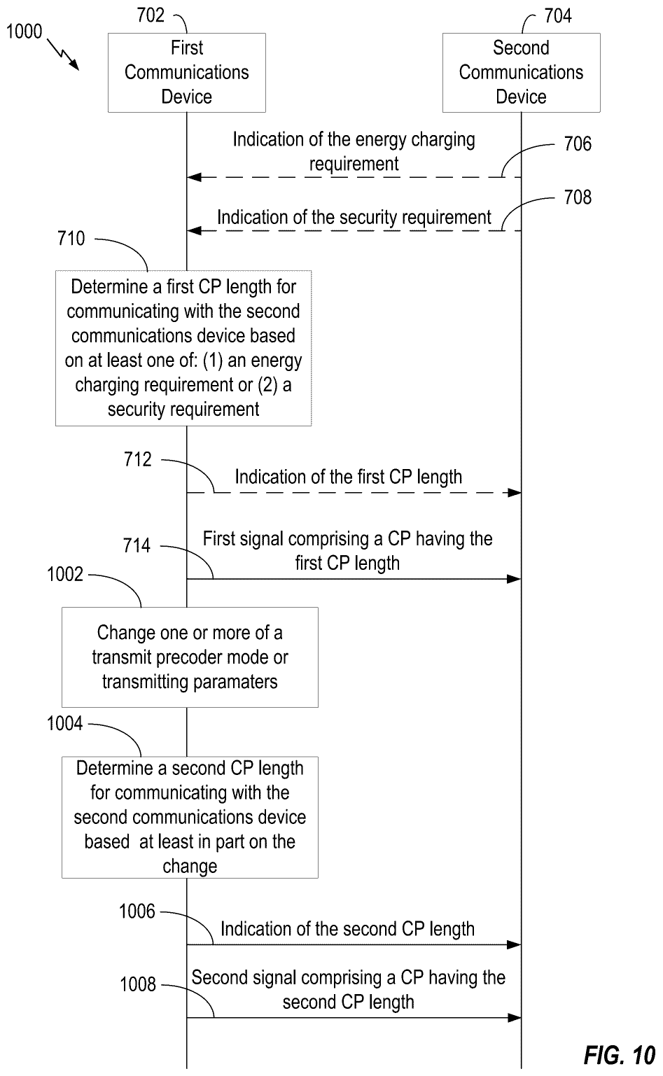

FIG. 10 depicts a process flow 1000 for communications in a network between communications devices for CP adaptation based on, at least, a change in a transmit precoder and/or transmitting parameters. In particular, FIG. 10 illustrates similar steps 706-714 present in FIG. 7; however, FIG. 10 further depicts a change in one or more of a transmit precoder mode or transmitting parameters which subsequently leads to a change in CP length used for a subsequent transmission (e.g., after transmission of the first signal at 714) to device 704.

For example, after transmitting, at 714, a first signal having the first CP length to device 704, at 1002, device 702 decides to use a transmit precoder mode and/or different transmitting parameters (e.g., than used previously) to transmit another signal to device 704. At 1004, device 702 determines a second CP length for communicating with device 704. Device 702 may determine the second CP length based, at least in part, on the change in transmit precoder mode and/or transmitting parameters.

In certain aspects, the change in transmit precoder mode and/or transmitting parameters used by device 702 may cause a smaller delay spread at device 704. Accordingly, a second CP length determined by device 702, at 1004, may be smaller than a CP length previously used. In particular, a smaller CP length may be needed based on the reduction in delay spread at device 704; thus, a smaller CP length may be feasible for transmission. In some cases, the smaller CP length may help to save resources and/or increase spectral and power efficiency.

In certain aspects, the change in transmit precoder mode and/or transmitting parameters used by device 702 may cause a larger delay spread at device 704. Accordingly, a second CP length determined by device 702, at 1004, may be larger than a CP length previously used. In particular, a larger CP length may be needed based on the increase in delay spread at device 704; thus, a larger CP length may be needed for transmission.

At 1006, device 702 transmits, to device 704, an indication to use the second CP length. In certain aspects, the indication indicates an absolute value of the second CP length. In certain other aspects, the indication indicates a difference in value between the first CP length and the second CP length. For example, where the second CP length is smaller by X (e.g., where X is a value greater than zero), the indication may include the value of X.

At 1008, device 702 transmits a second signal over a second symbol, wherein the second signal comprises a CP having the second CP length determined at 1004. Where the first CP length of the first signal is different than the second CP length of the second signal, the second signal transmitted at 1008 having the second CP length may have (1) increased/decreased energy transfer, (2) increased/decreased security, and/or (3) increased/decreased throughput in comparison to first signal.

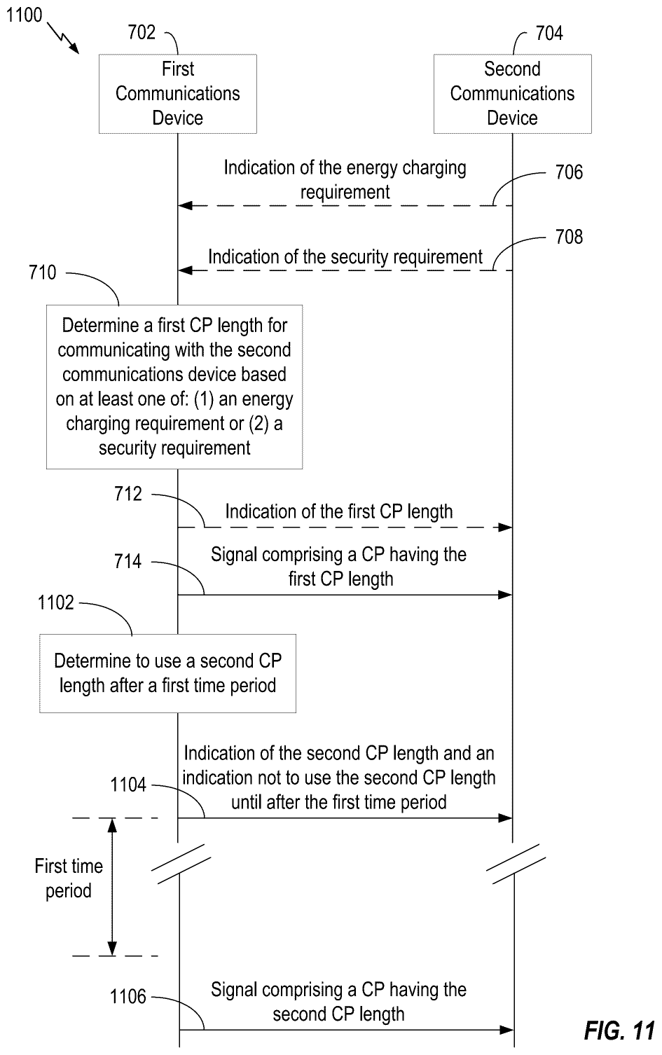

FIG. 11 depicts a process flow 1100 for communications in a network between communications devices for CP adaptation based on, at least, one or more periodic cycles configured for at least one of the communications devices. In particular, FIG. 11 illustrates similar steps 706-714 present in FIG. 7; however, FIG. 11 further depicts a change in CP length used for a subsequent transmission (e.g., after transmission of the first signal at 714) to device 704 based on periodic cycles configured for device 704 and/or device 704.

In certain aspects, device 702 and/or 704 may be configured with a periodic configuration for performing some action. For example, device 702 and/or device 704 may be configured with discontinuous reception (DRX) cycles, or other similar cycles. In particular, in a DRX mode of operation, device 702 and/or device 704 may enter a low power (“sleep”) mode for a certain period of time (referred to as a DRX OFF duration) and wake up again during a DRX ON duration to determine if there is any data to be received. The cycle of DRX ON and DRX OFF durations repeat periodically over time, allowing device 702 and/or device 704 to save power while maintaining communication. Accordingly, where device 702 and/or 704 is configured with such periodic cycles, device 702 may be configured to change a CP length used by device 702 for transmission only in frequencies that do not interfere with such configured cycles, such that system continuity, complexity, and parameter estimation is not adversely affected.

For example, after transmitting, at 714, a first signal having the first CP length to device 704, at 1102, device 702 may determine to change a CP length previously used for transmission. In other words, device 702 may determine to use a second CP length, where the first and second CP lengths are not the same. However, device 702 may determine that this change in CP length may not occur until after a first time period such that periodic cycles configured for device 702 and/or device 704 are not adversely affected.

At 1104, device 702 transmits an indication of the second CP length to device 704. Additionally, device 702 transmits an indication not to use the second CP length until after the first time period.

In certain aspects, the indication transmitted at 1104 may be transmitted in a wake up signal (WUS). For example, in certain aspects, device 704 may be configured with both DRX cycles, as well as a WUS configuration which configures multiple WUS occasions for device 704 to monitor for a WUS. A WUS may be used to indicate to device 704 whether an upcoming control channel signal resource includes information relevant to device 704. The WUS may be designed to allow for detection by device 704 with relatively simple, low power, processing. In this way, device 704 may more fully wake up to perform complex control channel signal processing only when the control channel includes signals relevant to device 704, thereby conserving battery power and resources of device 704. Jointly configuring a WUS configuration with a DRX configuration may add an extra layer of power saving before each DRX ON duration.

After the first time period has passed, the second CP length may be used for communication between device 702 and device 704. In particular, at 1106, device 702 transmits a second signal over a second symbol, wherein the second signal comprises a CP having the second CP length determined at 1106.

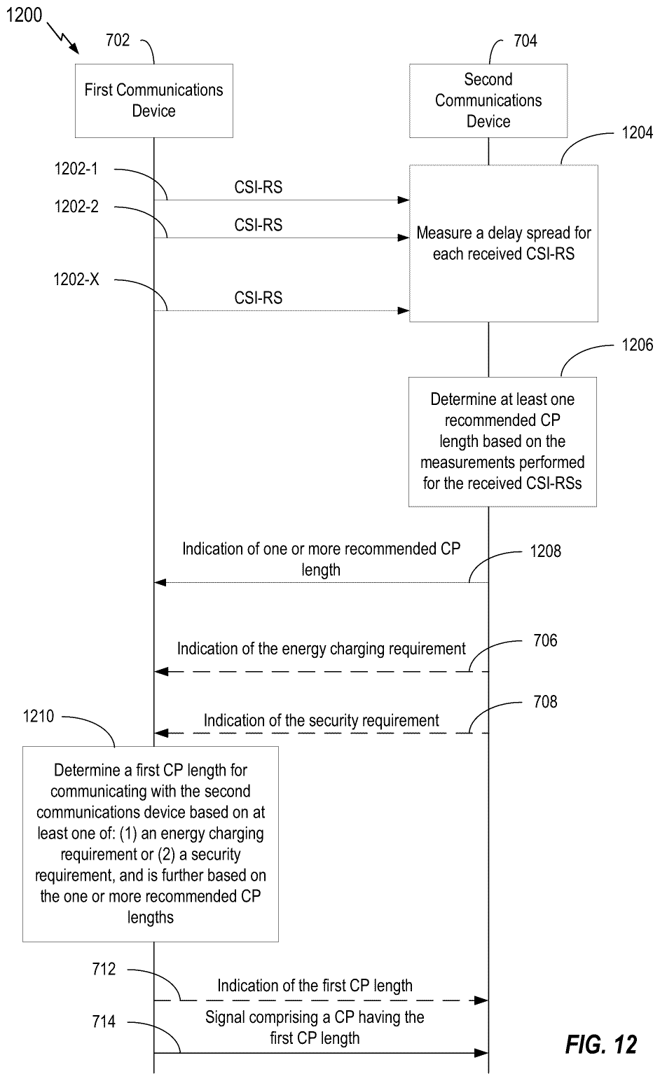

FIG. 12 depicts a process flow 1200 for communications in a network between communications devices for CP adaptation based on, at least, a plurality of delay spread measurements. In particular, CP adaptation may be based on explicit feedback from device 704, to device 702, regarding a plurality of delay spread measurements occurring at device 704.

As shown in FIG. 12, at 1202-1 through 1202-X (collectively referred to herein as 1202), device 702 transmits a plurality of channel state information (CSI)-reference signals (RSs), or other RSs, to device 704. In certain aspects, a different precoder is used to each CSI-RS transmitted to device 704 at 1202. For example, a precoder of CSI-RS transmitted at 1202-1 may be different than a precoder of CSI-RS transmitted at 1202-2.

In certain other aspects, a different precoder is used for different subsets of the plurality of CSI-RSs transmitted to device 704 at 1202. In certain aspects, a subset of CSI-RS may include one or more CSI-RSs. For example, where five CSI-RSs are transmitted to device 704, three subsets of CSI-RSs may be created for the five CSI-RSs. A first subset may include two of the five CSI-RSs, a second subset may include another two of the five CSI-RSs, and a third subset may include one of the five CSI-RSs. In this case, a different precoder may be used for each of the different three subsets.

At 1204, device 704 measures a delay spread for each received CSI-RSs. In certain aspects, such measurements may be used as an outer loop correction of the CP length.

At 1206, device 704 determines at least one recommended CP length based on, at least, the measurement performed for the received CSI-RSs. For example, device 704 determines at least one recommended CP length based on, at least, a measured delay spread for each received CSI-RS. In certain aspects, device 704 further determines at least one recommended CP length based on an energy charging requirement and/or (2) a security requirement for communications between device 702 and device 704.

At 1208, device 704 transmits an indication of one or more recommended CP lengths to device 704. The one or more recommended CP lengths may be indicated as absolute values, as a difference in value between each recommended CP length and a previously used CP length, or a combination of both.

At 1210, device 702 determines a first CP length for communicating with device 704. Device 702 may determine the first CP length based on at least one of: (1) an energy charging requirement or (2) a security requirement for communications between device 702 and device 704, and further based on the one or more recommended CP lengths.

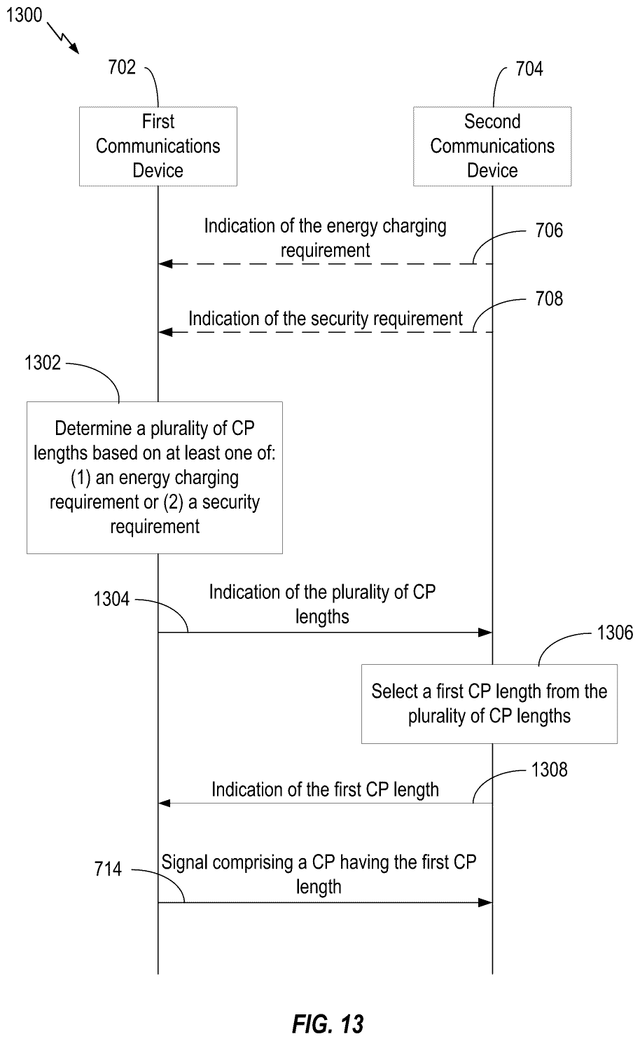

FIG. 13 depicts a process flow 1300 for communications in a network between communications devices for CP adaptation based on, at least, a recommended CP. For example, as shown in FIG. 13, at 1302, device 102 determines a plurality of CP lengths based on at least one of: (1) an energy charging requirement or (2) a security requirement for communications between device 702 and device 704, and subsequently at 1304, transmits an indication of the plurality of CP lengths to device 704.

In other words, device 702 may define a “state” for communication between device 702 and device 704. The “state” may be based on at least one of: (1) an energy charging requirement or (2) a security requirement for communications between device 702 and device 704. In certain aspects, the “state” may also be based on a transmitter precoder of device 702, transmitting parameters of device 702, reliability requirements, etc. For this defined “state”, device 702 may determine a plurality of feasible CP lengths. In certain aspects, the plurality may include only one CP length where only one CP length is feasible for the defined state.

At 1306, device 704 selects a first CP length from the plurality of CP lengths. In certain aspects, selection of the first CP length from the plurality of CP lengths may be random. As mentioned previously, random CP length selection may increase the security of wireless communications between device 702 and device 704. In particular, the randomization of selection of the CP length may help to confuse eavesdroppers of the communication, as well as active attackers.

At 1308, device 704 transmits an indication of the selected first CP length to device 702. The indication of the first CP length may be transmitted via a MAC-CE, a PDSCH, or RRC signaling. Device 702 subsequently transmits, at 714, a signal comprising a CP having the first CP length explicitly indicated to device 702.

In process flows 700-1300 of FIGS. 7-13, CP lengths of different signals transmitted by device 702 may continue to change. In certain aspects, such CP changes may be indicated to device 704 via L1/L2/L3 signaling from device 702. For example, such CP change may be indicated to device 704 via at least one of DCI, MAC-CE, a PDCCH, a PDSCH, or RRC signaling.

### Example Operations of a Communications Device

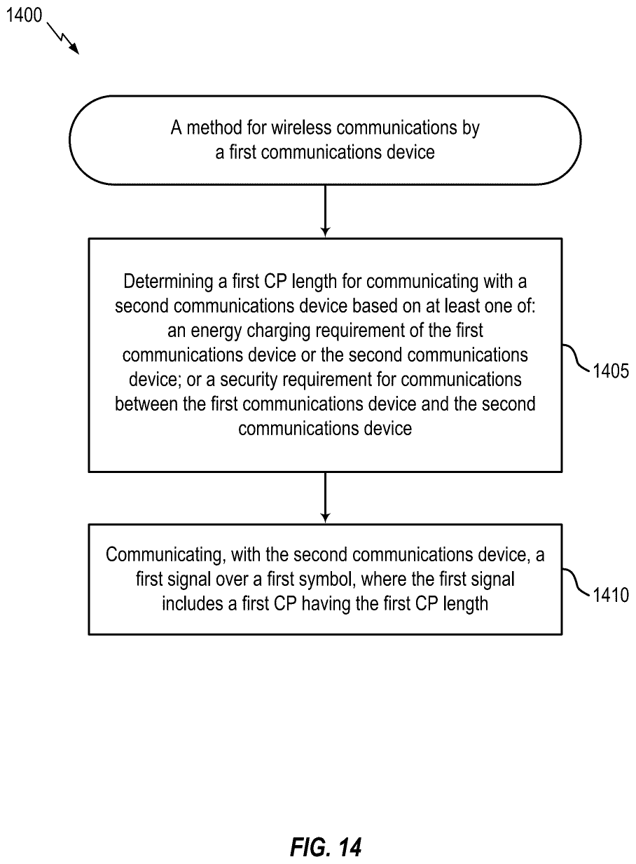

FIG. 14 shows a method 1400 for wireless communications by a first communications device, such as a UE 104 and/or a BS 102 of FIGS. 1 and 3, or a disaggregated BS as discussed with respect to FIG. 2.

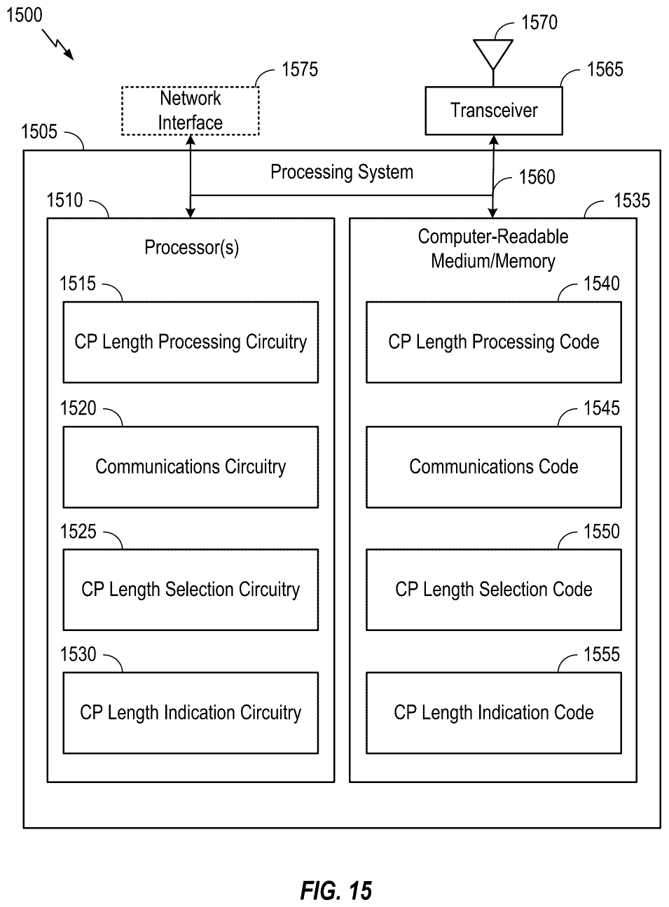

Method 1400 begins at 1405 with determining a first CP length for communicating with a second communications device based on at least one of: an energy charging requirement of the first communications device or the second communications device; or a security requirement for communications between the first communications device and the second communications device. In some cases, the operations of this step refer to, or may be performed by, CP length processing circuitry as described with reference to FIG. 15.

Method 1400 then proceeds to step 1410 with communicating, with the second communications device, a first signal over a first symbol, where the first signal includes a first CP having the first CP length. In some cases, the operations of this step refer to, or may be performed by, communications circuitry as described with reference to FIG. 15.

In some aspects, determining the first CP length is further based on a delay spread between the first communications device and the second communications device. In some aspects, the method 1400 further includes communicating, with the second communications device, an indication of the delay spread.

In some aspects, the method 1400 further includes communicating, with the second communications device, an indication of the at least one of the energy charging requirement or the security requirement. In some aspects, the first CP length is determined based on the energy charging requirement; and the energy charging requirement comprises a required amount of energy for the first communications device or the second communications device to at least one of decode the first signal or transmit a second signal. In some aspects, the first CP length is determined based on the security requirement; and the security requirement comprises a SINR degradation requirement.

In some aspects, the method 1400 further includes communicating, with the second communications device, a CP length configuration, wherein the CP length configuration associates each set of requirements of a plurality of sets of requirements with a corresponding set of CP lengths, wherein the at least one of the energy charging requirement or the security requirement is associated with a first set of requirements that is associated with a first set of CP lengths including the first CP length. In some aspects, each of the plurality of sets of requirements comprises one or more of a corresponding energy charging requirement, a corresponding security requirement, or a corresponding transmission parameter.

In some aspects, the method 1400 further includes communicating, with the second communications device, an indication to use a second CP length, for communication between the first communications device and the second communications device, in response to a change in one or more of a transmit precoder mode or transmitting parameters of the first communications device or the second communications device.

In some aspects, the method 1400 further includes communicating, with the second communications device, an indication to use a second CP length for communication between the first communications device and the second communications device. In some aspects, the method 1400 further includes communicating with the second communications device using the second CP length after waiting at least a first time period after communicating the first signal.

In some aspects, the method 1400 further includes communicating, with the second communications device, a plurality of CSI-RSs, wherein: a different precoder is used for each CSI-RS; or a different precoder is used for different subsets of the plurality of CSI-RSs. In some aspects, the method 1400 further includes communicating, with the second communications device, at least one recommended CP length associated based on measurements of the plurality of CSI-RSs as received at one of the first communications device or the second communications device, wherein the first CP length is based on the recommended CP length.

In some aspects, the method 1400 further includes communicating, with the second communications device, an indication of the first CP length via at least one of DCI, a MAC-CE, a PDCCH, a PDSCH, or RRC signaling. In some aspects, the indication comprises an absolute value of the first CP length. In some aspects, the indication comprises a difference in value of the first CP length from a previous CP length used for communication between the first communications device and the second communications device.

In some aspects, the method 1400 further includes communicating, with the second communications device, an indication of a plurality of CP lengths based on the at least one of the energy charging requirement and the security requirement. In some aspects, the method 1400 further includes selecting, by the first communications device, the first CP length from the plurality of CP lengths. In some aspects, the method 1400 further includes transmitting, to the second communications device, an indication of the first CP length. In some aspects, the indication of the first CP length is transmitted via a MAC-CE, a PDSCH, or RRC signaling.

In one aspect, method 1400, or any aspect related to it, may be performed by an apparatus, such as communications device 1500 of FIG. 15, which includes various components operable, configured, or adapted to perform the method 1400. Communications device 1500 is described below in further detail.

Note that FIG. 14 is just one example of a method, and other methods including fewer, additional, or alternative steps are possible consistent with this disclosure.

### Example Communications Device

FIG. 15 depicts aspects of an example first communications device 1500. In some aspects, first communications device 1500 is a UE or network entity, such as UE 104 and/or BS 102 of FIGS. 1 and 3, or a disaggregated BS as discussed with respect to FIG. 2.

The communications device 1500 includes a processing system 1505 coupled to the transceiver 1565 (e.g., a transmitter and/or a receiver). In some examples, processing system 1505 is coupled to a network interface 1575. The transceiver 1565 is configured to transmit and receive signals for the communications device 1500 via the antenna 1570, such as the various signals as described herein. The network interface 1575 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, cause the one or more processors 1510 to perform the method 1400 described with respect to FIG. 14, or any aspect related to it. Note that reference to a processor of communications device 1500 performing a function may include one or more processors 1510 of communications device 1500 performing that function.

In the depicted example, the computer-readable medium/memory 1535 stores code (e.g., executable instructions), such as CP length processing code 1540, communications code 1545, CP length selection code 1550, and CP length indication code 1555. Processing of the CP length processing code 1540, communications code 1545, CP length selection code 1550, and CP length indication code 1555 may cause the communications device 1500 to perform the method 1400 described with respect to FIG. 14, or any aspect related to it.

The one or more processors 1510 include circuitry configured to implement (e.g., execute) the code stored in the computer-readable medium/memory 1535, including circuitry such as CP length processing circuitry 1515, communications circuitry 1520, CP length selection circuitry 1525, and CP length indication circuitry 1530. Processing with CP length processing circuitry 1515, communications circuitry 1520, CP length selection circuitry 1525, and CP length indication circuitry 1530 may cause the communications device 1500 to perform the method 1400 as described with respect to FIG. 14, or any aspect related to it.

Various components of the communications device 1500 may provide means for performing the method 1400 as described with respect to FIG. 14, or any aspect related to it. Means for transmitting, sending or outputting for transmission may include transceivers 332 and/or antenna(s) 334 of the BS 102 illustrated in FIG. 3, transceivers 354 and/or antenna(s) 352 of the UE 104 illustrated in FIG. 3, and/or the transceiver 1565 and the antenna 1570 of the communications device 1500 in FIG. 15. Means for receiving or obtaining may include transceivers 332 and/or antenna(s) 334 of the BS 102 illustrated in FIG. 3, transceivers 354 and/or antenna(s) 352 of the UE 104 illustrated in FIG. 3, and/or the transceiver 1565 and the antenna 1570 of the communications device 1500 in FIG. 15.

According to some aspects, CP length processing circuitry 1515 determines a first CP length for communicating with a second communications device based on at least one of: an energy charging requirement of the first communications device 1500 or the second communications device; or a security requirement for communications between the first communications device 1500 and the second communications device.

According to some aspects, communications circuitry 1520 communicates, with the second communications device, a first signal over a first symbol, wherein the first signal comprises a first CP having the first CP length. In some aspects, determining the first CP length is further based on a delay spread between the first communications device 1500 and the second communications device. In some examples, communications circuitry 1520 communicates, with the second communications device, an indication of the delay spread. In some examples, communications circuitry 1520 communicates, with the second communications device, an indication of the at least one of the energy charging requirement or the security requirement. In some aspects, the first CP length is determined based on the energy charging requirement; and the energy charging requirement comprises a required amount of energy for the first communications device 1500 or the second communications device to at least one of decode the first signal or transmit a second signal. In some aspects, the first CP length is determined based on the security requirement; and the security requirement comprises a SINR degradation requirement.

In some examples, CP length indication circuitry 1530 communicates, with the second communications device, a CP length configuration, wherein the CP length configuration associates each set of requirements of a plurality of sets of requirements with a corresponding set of CP lengths, wherein the at least one of the energy charging requirement or the security requirement is associated with a first set of requirements that is associated with a first set of CP lengths including the first CP length. In some aspects, each of the plurality of sets of requirements comprises one or more of a corresponding energy charging requirement, a corresponding security requirement, or a corresponding transmission parameter. In some examples, CP length indication circuitry 1530 communicates, with the second communications device, an indication to use a second CP length, for communication between the first communications device 1500 and the second communications device, in response to a change in one or more of a transmit precoder mode or transmitting parameters of the first communications device 1500 or the second communications device. In some examples, CP length indication circuitry 1530 communicates, with the second communications device, an indication to use a second CP length for communication between the first communications device 1500 and the second communications device. In some examples, communications circuitry 1520 communicates with the second communications device using the second CP length after waiting at least a first time period after communicating the first signal.

In some examples, communications circuitry 1520 communicates, with the second communications device, a plurality of CSI-RSs, wherein: a different precoder is used for each CSI-RS; or a different precoder is used for different subsets of the plurality of CSI-RSs. In some examples, communications circuitry 1520 communicates, with the second communications device, at least one recommended CP length associated based on measurements of the plurality of CSI-RSs as received at one of the first communications device 1500 or the second communications device, wherein the first CP length is based on the recommended CP length.

In some examples, CP length indication circuitry 1530 communicates, with the second communications device, an indication of the first CP length via at least one of DCI, a MAC-CE, a PDCCH, a PDSCH, or RRC signaling. In some aspects, the indication comprises an absolute value of the first CP length. In some aspects, the indication comprises a difference in value of the first CP length from a previous CP length used for communication between the first communications device 1500 and the second communications device. In some examples, CP length indication circuitry 1530 communicates, with the second communications device, an indication of a plurality of CP lengths based on the at least one of the energy charging requirement and the security requirement.

According to some aspects, CP length selection circuitry 1525 selects, by the first communications device 1500, the first CP length from the plurality of CP lengths. According to some aspects, CP length indication circuitry 1530 transmits, to the second communications device, an indication of the first CP length. In some aspects, the indication of the first CP length is transmitted via a MAC-CE, a PDSCH, or RRC signaling.

### Example Clauses

Implementation examples are described in the following numbered clauses:

Clause 1: A method for wireless communication by a first communications device, comprising: determining a first CP length for communicating with a second communications device based on at least one of: an energy charging requirement of the first communications device or the second communications device, or a security requirement for communications between the first communications device and the second communications device; and communicating, with the second communications device, a first signal over a first symbol, wherein the first signal comprises a first CP having the first CP length.

Clause 2: The method of Clause 1, wherein determining the first CP length is further based on a delay spread between the first communications device and the second communications device.

Clause 3: The method of Clause 2, further comprising: communicating, with the second communications device, an indication of the delay spread.

Clause 4: The method of any one of Clauses 1-3, further comprising: communicating, with the second communications device, an indication of the at least one of the energy charging requirement or the security requirement.

Clause 5: The method of any one of Clauses 1-4, wherein: the first CP length is determined based on the energy charging requirement; and the energy charging requirement comprises a required amount of energy for the first communications device or the second communications device to at least one of decode the first signal or transmit a second signal.

Clause 6: The method of any one of Clauses 1-5, wherein the first CP length is determined based on the security requirement; and the security requirement comprises a SINR degradation requirement.

Clause 7: The method of any one of Clauses 1-6, further comprising: communicating, with the second communications device, a CP length configuration, wherein the CP length configuration associates each set of requirements of a plurality of sets of requirements with a corresponding set of CP lengths, wherein the at least one of the energy charging requirement or the security requirement is associated with a first set of requirements that is associated with a first set of CP lengths including the first CP length.

Clause 8: The method of Clause 7, wherein each of the plurality of sets of requirements comprises one or more of a corresponding energy charging requirement, a corresponding security requirement, or a corresponding transmission parameter.

Clause 9: The method of any one of Clauses 1-8, further comprising: communicating, with the second communications device, an indication to use a second CP length, for communication between the first communications device and the second communications device, in response to a change in one or more of a transmit precoder mode or transmitting parameters of the first communications device or the second communications device.

Clause 10: The method of any one of Clauses 1-9, further comprising: communicating, with the second communications device, an indication to use a second CP length for communication between the first communications device and the second communications device; and communicating with the second communications device using the second CP length after waiting at least a first time period after communicating the first signal.

Clause 11: The method of any one of Clauses 1-10, further comprising: communicating, with the second communications device, a plurality of CSI-RSs, wherein: a different precoder is used for each CSI-RS; or a different precoder is used for different subsets of the plurality of CSI-RSs; and communicating, with the second communications device, at least one recommended CP length associated based on measurements of the plurality of CSI-RSs as received at one of the first communications device or the second communications device, wherein the first CP length is based on the recommended CP length.

Clause 12: The method of any one of Clauses 1-11, further comprising: communicating, with the second communications device, an indication of the first CP length via at least one of DCI, a MAC-CE, a PDCCH, a PDSCH, or RRC signaling.

Clause 13: The method of Clause 12, wherein the indication comprises an absolute value of the first CP length.

Clause 14: The method of Clause 12, wherein: the indication comprises a difference in value of the first CP length from a previous CP length used for communication between the first communications device and the second communications device.

Clause 15: The method of any one of Clauses 1-14, further comprising: communicating, with the second communications device, an indication of a plurality of CP lengths based on the at least one of the energy charging requirement and the security requirement.

Clause 16: The method of Clause 15, further comprising: selecting, by the first communications device, the first CP length from the plurality of CP lengths; and transmitting, to the second communications device, an indication of the first CP length.

Clause 17: The method of Clause 16, wherein the indication of the first CP length is transmitted via a MAC-CE, a PDSCH, or RRC signaling.

Clause 18: A processing system, comprising: a memory comprising computer-executable instructions; one or more processors configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a first communications device, comprising:
determining a first cyclic prefix (CP) length for communicating with a second communications device based on at least one of:
an energy charging requirement of the first communications device or the second communications device; or
a security requirement for communications between the first communications device and the second communications device; and
communicating, with the second communications device, a first signal over a first symbol, wherein the first signal comprises a first CP having the first CP length.

2. The method of claim 1, wherein determining the first CP length is further based on a delay spread between the first communications device and the second communications device.

3. The method of claim 2, further comprising communicating, with the second communications device, an indication of the delay spread.

4. The method of claim 1, further comprising communicating, with the second communications device, an indication of the at least one of the energy charging requirement or the security requirement.

5. The method of claim 1, wherein:
the first CP length is determined based on the energy charging requirement; and
the energy charging requirement comprises a required amount of energy for the first communications device or the second communications device to at least one of decode the first signal or transmit a second signal.

6. The method of claim 1, wherein:
the first CP length is determined based on the security requirement; and
the security requirement comprises a signal to interference plus noise (SINR) degradation requirement.

7. The method of claim 1, further comprising communicating, with the second communications device, a CP length configuration, wherein the CP length configuration associates each set of requirements of a plurality of sets of requirements with a corresponding set of CP lengths, wherein the at least one of the energy charging requirement or the security requirement is associated with a first set of requirements that is associated with a first set of CP lengths including the first CP length.

8. The method of claim 7, wherein each of the plurality of sets of requirements comprises one or more of a corresponding energy charging requirement, a corresponding security requirement, or a corresponding transmission parameter.

9. The method of claim 1, further comprising communicating, with the second communications device, an indication to use a second CP length, for communication between the first communications device and the second communications device, in response to a change in one or more of a transmit precoder mode or transmitting parameters of the first communications device or the second communications device.

10. The method of claim 1, further comprising:
communicating, with the second communications device, an indication to use a second CP length for communication between the first communications device and the second communications device; and
communicating with the second communications device using the second CP length after waiting at least a first time period after communicating the first signal.

11. The method of claim 1, further comprising:
communicating, with the second communications device, a plurality of channel state information (CSI)-reference signals (RSs), wherein:
a different precoder is used for each CSI-RS; or
a different precoder is used for different subsets of the plurality of CSI-RSs; and
communicating, with the second communications device, at least one recommended CP length associated based on measurements of the plurality of CSI-RSs as received at one of the first communications device or the second communications device, wherein the first CP length is based on the recommended CP length.

12. The method of claim 1, further comprising communicating, with the second communications device, an indication of the first CP length via at least one of downlink control information (DCI), a medium access control (MAC) control element (CE), a physical downlink control channel (PDCCH), a physical downlink shared channel (PDSCH), or radio resource control (RRC) signaling.

13. The method of claim 12, wherein the indication comprises an absolute value of the first CP length.

14. The method of claim 12, wherein the indication comprises a difference in value of the first CP length from a previous CP length used for communication between the first communications device and the second communications device.

15. The method of claim 1, further comprising:
communicating, with the second communications device, an indication of a plurality of CP lengths based on the at least one of the energy charging requirement and the security requirement.

16. The method of claim 15, further comprising:
selecting, by the first communications device, the first CP length from the plurality of CP lengths; and
transmitting, to the second communications device, an indication of the first CP length.

17. The method of claim 16, wherein the indication of the first CP length is transmitted via a medium access control (MAC) control element (CE), a physical downlink shared channel (PDSCH), or radio resource control (RRC) signaling.

18. A first communications device configured for wireless communications, comprising:
a memory comprising computer-executable instructions; and
a processor configured to execute the computer-executable instructions and cause the first communications device to:
determine a first cyclic prefix (CP) length for communicating with a second communications device based on at least one of:
an energy charging requirement of the first communications device or the second communications device; or
a security requirement for communications between the first communications device and the second communications device; and
communicate, with the second communications device, a first signal over a first symbol, wherein the first signal comprises a first CP having the first CP length.

19. The first communications device of claim 18, wherein the processor is configured to execute the computer-executable instructions and cause the first communications device to determine the first CP length further based on a delay spread between the first communications device and the second communications device.

20. The first communications device of claim 19, wherein the processor is configured to execute the computer-executable instructions and further cause the first communications device to:
communicate, with the second communications device, an indication of the delay spread.

21. The first communications device of claim 18, wherein the processor is configured to execute the computer-executable instructions and further cause the first communications device to:
communicate, with the second communications device, an indication of the at least one of the energy charging requirement or the security requirement.

22. The first communications device of claim 18, wherein:
the first CP length is determined based on the energy charging requirement; and
the energy charging requirement comprises a required amount of energy for the first communications device or the second communications device to at least one of decode the first signal or transmit a second signal.

23. The first communications device of claim 18, wherein:
the first CP length is determined based on the security requirement; and
the security requirement comprises a signal to interference plus noise (SINR) degradation requirement.

24. The first communications device of claim 18, wherein the processor is configured to execute the computer-executable instructions and further cause the first communications device to:
communicate, with the second communications device, a CP length configuration, wherein the CP length configuration associates each set of requirements of a plurality of sets of requirements with a corresponding set of CP lengths, wherein the at least one of the energy charging requirement or the security requirement is associated with a first set of requirements that is associated with a first set of CP lengths including the first CP length.

25. The first communications device of claim 24, wherein each of the plurality of sets of requirements comprises one or more of a corresponding energy charging requirement, a corresponding security requirement, or a corresponding transmission parameter.

26. The first communications device of claim 18, wherein the processor is configured to execute the computer-executable instructions and further cause the first communications device to:
communicate, with the second communications device, an indication to use a second CP length, for communication between the first communications device and the second communications device, in response to a change in one or more of a transmit precoder mode or transmitting parameters of the first communications device or the second communications device.

27. The first communications device of claim 18, wherein the processor is configured to execute the computer-executable instructions and further cause the first communications device to:
communicate, with the second communications device, an indication to use a second CP length for communication between the first communications device and the second communications device; and
communicate with the second communications device using the second CP length after waiting at least a first time period after communicating the first signal.

28. The first communications device of claim 18, wherein the processor is configured to execute the computer-executable instructions and further cause the first communications device to:
communicate, with the second communications device, a plurality of channel state information (CSI)-reference signals (RSs), wherein:
a different precoder is used for each CSI-RS; or
a different precoder is used for different subsets of the plurality of CSI-RSs; and
communicate, with the second communications device, at least one recommended CP length associated based on measurements of the plurality of CSI-RSs as received at one of the first communications device or the second communications device, wherein the first CP length is based on the recommended CP length.

29. A non-transitory computer-readable medium comprising computer-executable instructions that, when executed by a processor of a first communications device, cause the first communications device to perform a method comprising:
determining a first cyclic prefix (CP) length for communicating with a second communications device based on at least one of:
an energy charging requirement of the first communications device or the second communications device; or
a security requirement for communications between the first communications device and the second communications device; and
communicating, with the second communications device, a first signal over a first symbol, wherein the first signal comprises a first CP having the first CP length.

30. A first communications device configured for wireless communications, comprising:
means for determining a first cyclic prefix (CP) length for communicating with a second communications device based on at least one of:
an energy charging requirement of the first communications device or the second communications device; or
a security requirement for communications between the first communications device and the second communications device; and
means for communicating, with the second communications device, a first signal over a first symbol, wherein the first signal comprises a first CP having the first CP length.
